(19) United States
(12) Patent Application Publication
(10) Pub. No.: US 2024/0093600 A1
(43) Pub. Date: Mar. 21, 2024

(54) Quantitative Prediction and Sorting of Carbon Underground Treatment and Sequestration of Potential Formations

(71) Applicant: Saudi Arabian Oil Company, Dhahran (SA)

(72) Inventors: Weichang Li, Katy, TX (US); Katherine Leigh Hull, Houston, TX (US); Younane N. Abousleiman, Norman, OK (US)

(21) Appl. No.: 17/946,346

(22) Filed: Sep. 16, 2022

(51) Int. Cl. E21B 47/12

(52) U.S. Cl. CPC E21B 47/12; E21B 2200/20; E21B 2200/22

(57) ABSTRACT

A computer-implemented method for quantitative prediction and sorting of carbon underground treatment and sequestration is described. The method includes preprocessing multiple data sets, wherein the multiple datasets are multi-modal and multiscale data sets. The method also includes predicting geological structural properties, chemical properties, and geological properties by inputting the preprocessed multiple data sets into trained machine learning models. Additionally, the method includes ranking the storage and treatment potential of a formation based on the predicted geological structural properties, chemical properties, and geological properties.

### TECHNICAL FIELD

This disclosure relates generally to underground carbon storage.

### BACKGROUND

Carbon dioxide (CO₂) can be captured from sources, then reused or stored permanently. Sources of CO₂ include energy production processes, manufacturing, and the like. CO₂ can be removed directly from the air. Storage locations of captured CO₂ include underground locations, such as geological formations including oil and gas reservoirs.

### SUMMARY

An embodiment described herein provides a computer-implemented method for quantitative prediction and sorting of carbon underground treatment and sequestration of potential formations. The method includes preprocessing, with one or more hardware processors, multiple data sets, wherein the multiple datasets are multi-modal and multiscale data sets. The method also includes predicting, with the one or more hardware processors, geological structural properties, chemical properties, and geological properties by inputting the preprocessed multiple data sets into trained machine learning models. Additionally, the method includes ranking, with the one or more hardware processors, the storage and treatment potential of a formation based on the predicted geological structural properties, chemical properties, and geological properties.

An embodiment described herein provides an apparatus comprising a non-transitory, computer readable, storage medium that stores instructions that, when executed by at least one processor, cause the at least one processor to perform operations. The operations include preprocessing multiple data sets, wherein the multiple datasets are multi-modal and multiscale data sets. The operations also include predicting geological structural properties, chemical properties, and geological properties by inputting the preprocessed multiple data sets into trained machine learning models. Additionally, the operations include ranking the storage and treatment potential of a formation based on the predicted geological structural properties, chemical properties, and geological properties.

An embodiment described herein provides a system. The system comprises one or more memory modules and one or more hardware processors communicably coupled to the one or more memory modules. The one or more hardware processors are configured to execute instructions stored on the one or more memory models to perform operations. The operations include preprocessing multiple data sets, wherein the multiple datasets are multi-modal and multiscale data sets. The operations also include predicting geological structural properties, chemical properties, and geological properties by inputting the preprocessed multiple data sets into trained machine learning models. Additionally, the operations include ranking the storage and treatment potential of a formation based on the predicted geological structural properties, chemical properties, and geological properties.

### BRIEF DESCRIPTION OF DRAWINGS

FIG. 1 is an illustration of a workflow that enables quantitative prediction and sorting of carbon underground treatment and sequestration (QPCUTS) for potential formations.

FIG. 2 shows increased porosity and permeability throughout the organic matter following oxidative treatment of an organic-rich shale sample.

FIG. 3 shows a workflow for training machine learning models to predict structural and geological properties for flow and storage potential.

FIG. 4 shows rock facies type grouping based on structural properties for flow and storage potential.

FIG. 5 shows a workflow for training machine learning models to predict chemical properties for flow and storage potential.

FIG. 6 shows chemical facies type grouping based on chemical properties for fluid additives treatment potential.

FIG. 7 is a process flow diagram of a process for quantitative prediction and sorting of carbon underground treatment and sequestration.

FIG. 8 is a schematic illustration of an example controller for quantitative prediction and sorting of carbon underground treatment and sequestration of potential formations.

### DETAILED DESCRIPTION

Carbon capture refers to the capture of carbon dioxide (CO₂) to prevent the emission of CO₂ into the atmosphere. In some cases, carbon capture refers to the removal of CO₂ from the atmosphere. In carbon capture, sequestration, and storage, potential geological formations are identified as candidate storage sites which have desired rock and flow characteristics, i.e., porosity and permeability. Geological formations include rock types rich in organic matter such as source shale (kerogen/bitumen), coal seams, and any other types of formations with organic content that can host the CO₂. The organic matter can be subjected to oxidative chemical treatment, yielding increased structural porosity related to the organic matter content, increasing the surface area of a formation via augmented multi-porosity, and enhancing hydraulic diffusivity facilitating the flow of CO₂. The chemical treatment facilitates the absorption and adsorption of CO₂ to the treated organic matter, enabling a permanent sequestration of CO₂.

Embodiments described herein enable quantitative prediction and sorting of carbon underground treatment and sequestration (QPCUTS) for potential formations. Identifying and characterizing properties including the total organic matter (TOC) content, the oxidative fluid treatability, and mineralogical characteristics of rock types in geological formations is performed for storage potential assessment and permanent sequestration, rather than simply using limited geological structural information, formation porosity, and storage volume capacity. In examples, a machine learning based quantitative approach predicts and characterizes properties including the organic content and the rock matrix properties of a formation. In examples, the present techniques predict geological structural properties, chemical properties, and geological properties. The present techniques predict both the types of organic content and the level of these organic content in the rock, as well as the rock matrix properties such as porosity and permeability. In examples, the input data includes analytical rock sample data obtained from lab experiments, thin-sections, rock cuttings, and core slab and core plugs measurements, well log data and geophysical surveys measured in the field, as well as petrophysical and geological models when they are available.

The predictions and characterizations are used to quantify, sort, and rank the storage and treatment potential of various geological formations in view of the respective organic content of the formation and the associated economics. This provides an automated and quantitative platform that can be broadly applied to assess and evaluate candidate deep underground storage sites both technologically as well as economically.

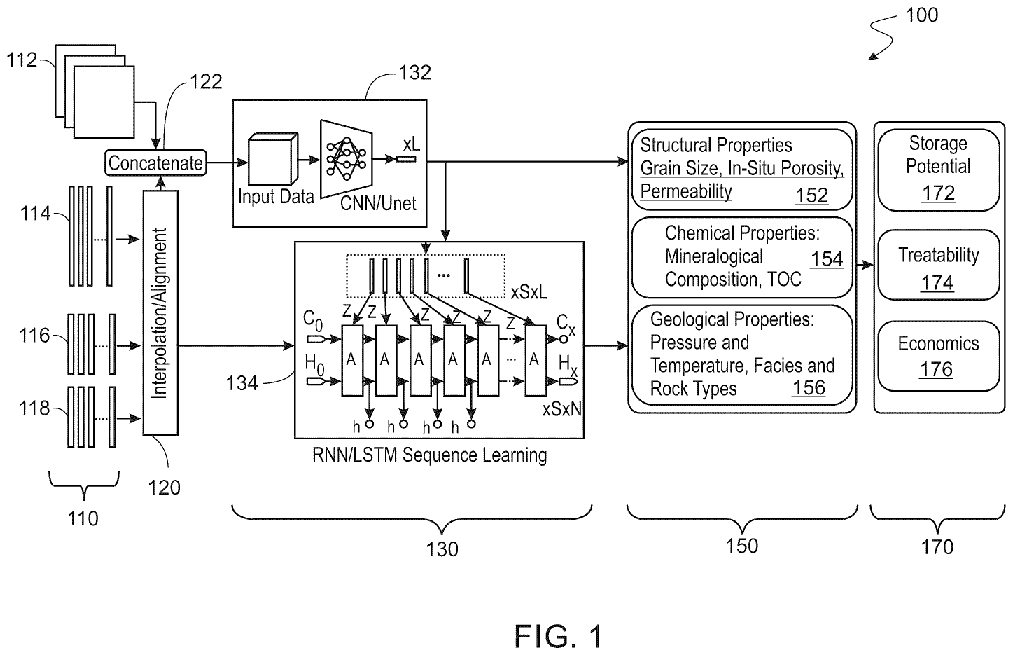

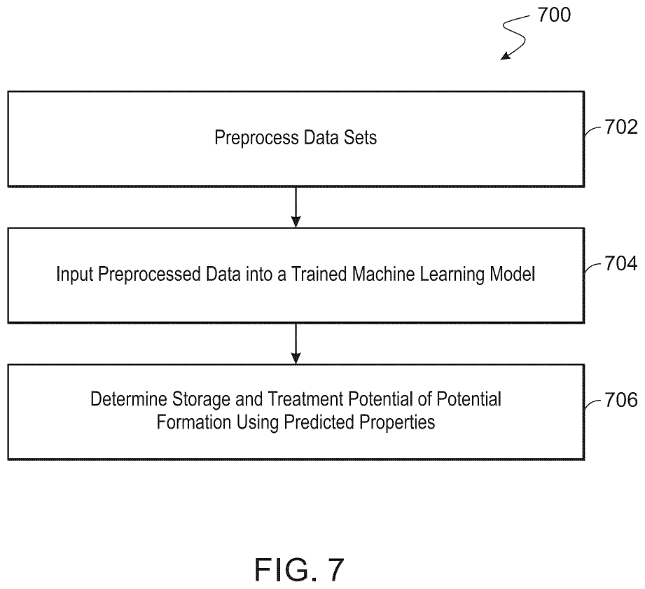

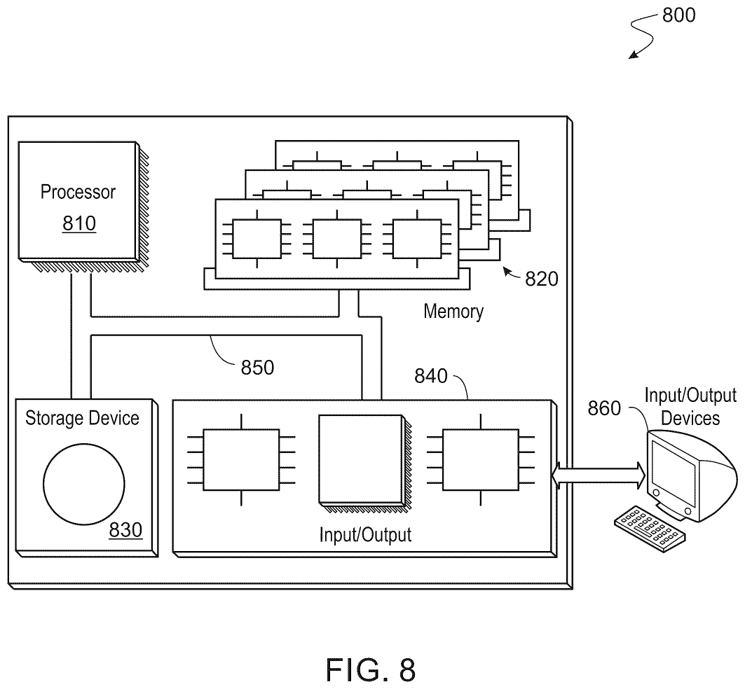

FIG. 1 is an illustration of a workflow 100 that enables quantitative prediction and sorting of carbon underground treatment and sequestration (QPCUTS) for potential formations. The workflow 100 may be executed using the process 700 of FIG. 7, using the system 800 of FIG. 8. In the example of FIG. 1, an overall workflow 100 includes input data 110, machine learning models 130, and predicted variables and properties 150.

In some embodiments, the present techniques include an automated and quantitative system/platform that is broadly deployed to assess and evaluate candidate underground storage sites for CO₂ across the globe both technologically as well as economically. The system is based on machine learning models and algorithms 130 which form the workflow 100. In the example of FIG. 1, multimodal and multiscale data sets are shown as the input data sets 110. The multimodal and multiscale data sets are preprocessed to generate input data sets 110 that are input to machine learning models 130. The machine learning models 130 predict properties 150. The properties 150 are used to identify carbon underground treatment and sequestration (QPCUTS) 170 for potential formations.

In the example of FIG. 1, the multimodal and multiscale data is aggregated, cleaned, and integrated to form input data sets 110. In examples, the input datasets are obtained from many different sources, either surveys, logging data obtained from fields (e.g., field measurements), analytical measurements from samples in the lab, or model constraints or knowledge, and the like. For example, the multimodal and multiscale data includes images 112, rock sample analytical data 114, well log and field data 116, and models 118.

Images 112 include thin-sections, rock cuttings, core slab measurements, core plug measurements, core images, borehole image logs, geophysical images/volumes, and the like. Thin sections include scanning electron microscopy (SEM), computed tomography (CT), fluorescence, Fourier Transform-Infrared (FTIR), petrology micrograph, and the like. Core images include white light, ultraviolet (UV), CT, and the like. Geophysical images/volumes include seismic sections, attribute volumes, vertical seismic profile (VSP), electromagnetic (EM) resistivity, and the like. In examples, the images 112 are two-dimensional (2D) or three-dimensional (3D) images.

FIG. 1 shows rock sample analytical data 114. In examples, the rock sample analytical data 114 is obtained from lab experiments. The rock sample analytical data 114 includes core plugs and/or drill cutting. In examples, core plug/drill cutting data includes grain density, porosity, permeability, TOC, elemental and mineral x-ray diffraction (XRD), x-ray fluorescence (XRF), NMR, IR, and the like. The rock sample analytical data 114 includes thin sections. The thin sections include elemental/mineral/kerogen maturity attributes. The rock sample analytical data 114 also includes chemical treatment data. In examples, the rock sample analytical data 114 is multiple sequence and time series data.

FIG. 1 shows well log and field data 116. In examples, well log data and geophysical surveys are measured in the field. Well logs include acoustic, caliper, chemical, density, gamma, neutron, images logs, mud logging and the like. In embodiments, the well log data is multiple sequence data. The field data includes injection/production history. In examples, the field data is spatial-time data. FIG. 1 shows models 118. The models include geological/petrophysical models. In examples, the models 118 include constraints, bounds, and categorical data.

As illustrated in the example of FIG. 1, the rock sample analytical data 114, well logs and field data 116, and models 118 are input to preprocessing 120. In examples, the preprocessing 120 includes interpolating and aligning the rock sample analytical data 114, well logs and field data 116, and models 118 to obtain interpolated and aligned data.

To aggregate these data and integrate them in forms that can be used jointly in the machine learning prediction models 130, the input data sets 110 are grouped into four categories. The first group is the images 112, including 2D or 3D images such as thin section images (SEM, CT, fluorescence, FTIR, petrography etc.), core images, borehole image logs, geophysical images/volumes. The second group is field production history as spatial-time series data, such as rock sample analytical data 114. The third group is sequence and time series data, such as well log and field data 116 including well log/drilling data, and core analysis data including density, porosity, permeability, TOC, XRD, XRF, IR etc. The fourth group is geological and petrophysical models 118 that can be incorporated as constraints, bounds and categorical data. In examples, the preprocessing 120 includes aggregating the input data to group data with a similar number of dimensionality together.

For example, well logs such as a Gamma log are a single scalar function of depth. Core images are two dimensional (2D), and micro CT images are three dimensional 3D). While in higher dimensions, the 2D and 3D data are often available in much sparse sampling intervals. In examples, each data type is then interpolated or extrapolated for compatibility among each data type. In examples, for preprocessing of both images and sequence or time series data, missing data is identified, and interpolation and extrapolation applied for small gaps. The data is partitioned into smaller sizes (e.g., window or image sizes) that match dimensions of the machine learning model inputs. In examples, extreme value/outlier removal (e.g. Z-score, principle component analysis (PCA), etc.) and filtering based noise removal is performed to clean the data as needed. In examples, data cleaning is performed before machine learning model development and training. This is done to the raw data form or some preprocessed (e.g. truncated and windowed) versions of the data for dimension matching and processing convenience. In embodiments, preprocessing includes applying interpolation to a first data set so that a dimension of the first data set is equal to a dimension of a second data set.

At concatenator 122, the images 112 and the preprocessed data from preprocessing 120 are concatenated. The input data sets, including preprocessed multimodal and multiscale data and the preprocessed multimodal and multiscale data concatenated with images, are input to machine learning models 130. The different data types are integrated via different input forms (image matrices, sequence vectors), concatenated, and aligned with each other along the common axes. In examples, the data is organized into compatible forms as a single aggregate input into the prediction models to collectively predict the target formation properties and potential.

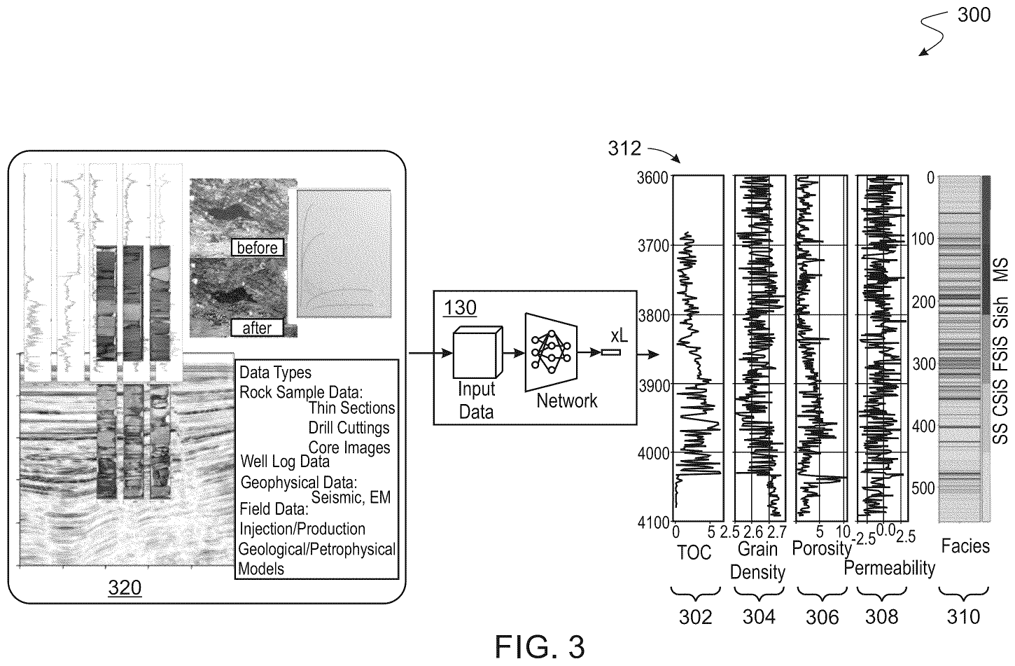

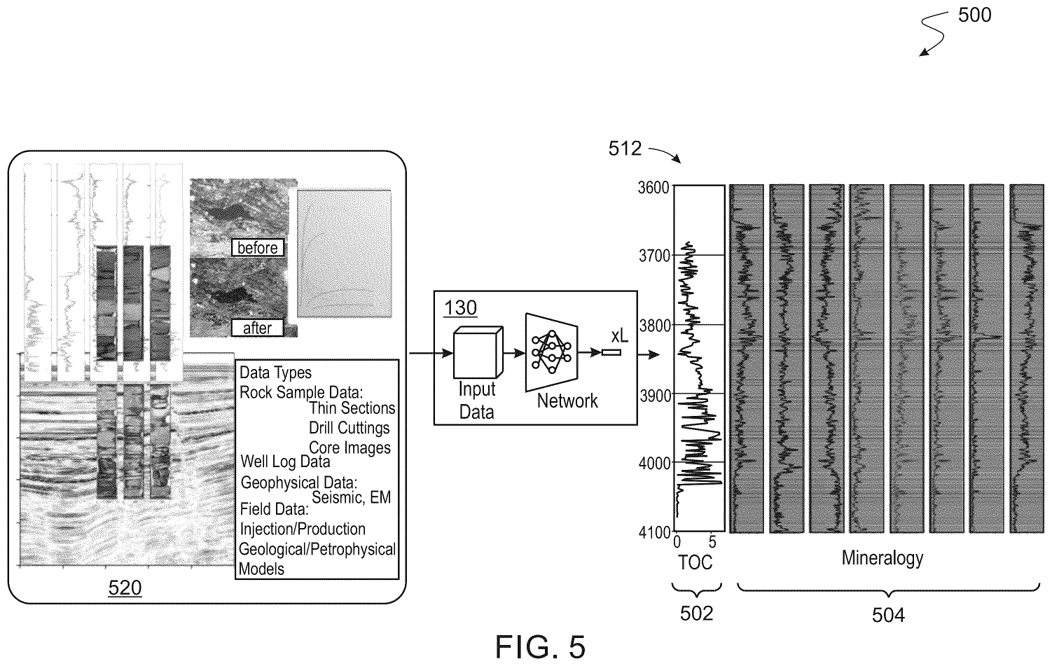

The preprocessed and/or concatenated input data sets 110 are provided as input to trained machine learning models 130. In examples, the concatenated data from the concatenator 122 is input to a trained machine learning model 132. In embodiments, the trained machine learning model 132 is a convolutional neural network that takes as input point data of the concatenated and preprocessed multiple data sets. The interpolated and aligned data from preprocessing 120 is input to a machine learning model 134. In embodiments, the trained machine learning model 134 is a recurrent neural network that takes as input sequence data of the preprocessed multiple data sets. In examples, the machine learning models 130 (e.g., machine learning model 132 and machine learning model 134) quantitatively predict and characterize formation and rock properties 150. In examples, the trained machine learning models execute simultaneously to output predicted properties 150. The predicted properties 150 include but are not limited to geological structural properties 152, chemical properties 154, and geological properties 156. Geological structural properties 152 include, for example, faults, formation cap seal, grain size, in-situ porosity, and permeability. Chemical properties 154 include, for example, mineralogical composition, TOC, maturity, kerogen/bitumen ratio, and spatial distribution. Geological properties 156 include, for example, pressure and temperature, facies and rock types. Prediction of structural properties (porosity/permeability) and geological properties (facies and rock types) for flow and storage potential is discussed further with respect to FIG. 3. Prediction of chemical properties including a percentage of volumes (e.g., TOC and mineralogy) for rocks that are capable of being treated to improve CO₂ uptake is discussed further with respect to FIG. 5. In examples, during training target output variables of a training sample set are selected based on the geological structural properties, chemical properties, and geological properties to be predicted by the trained machine learning models.

QPCUTS 170 are identified for potential formations based on the predicted properties 150. One or more of a storage potential 172, treatability 174, and economic potential 176 of various geological formation is identified, quantified, sorted, and ranked. In examples, the storage potential refers to the amount of CO₂ that could be stored in a given rock formation. The treatability 174 describes the fluid treatment potential of the formation. The economic potential refers to associated economics that are determined by incorporating these prediction and characterization from the multimodal and multiscale data sets 110 and the predicted properties 150. The economic potential describes the associated cost of developing the potential formation into storage site versus the potential storage potential, which is function of the depth, the volume, the porosity and the treatability. In examples, identification of the storage and fluid treatment potential includes a location, storage volume capacity, depth, or any combinations thereof.

The block diagram of FIG. 1 is not intended to indicate that the workflow 100 is to include all of the components shown in FIG. 1. Rather, the workflow 100 can include fewer or additional components not illustrated in FIG. 1 (for example, additional models, additional preprocessing, and the like). The workflow 100 may include any number of additional components not shown, depending on the details of the specific implementation. Furthermore, any of the functionalities of the workflow 100 may be partially, or entirely, implemented in hardware and/or in a processor. For example, the functionality may be implemented with an application specific integrated circuit, in logic implemented in a processor, in logic implemented in a specialized graphics processing unit, or in any other device.

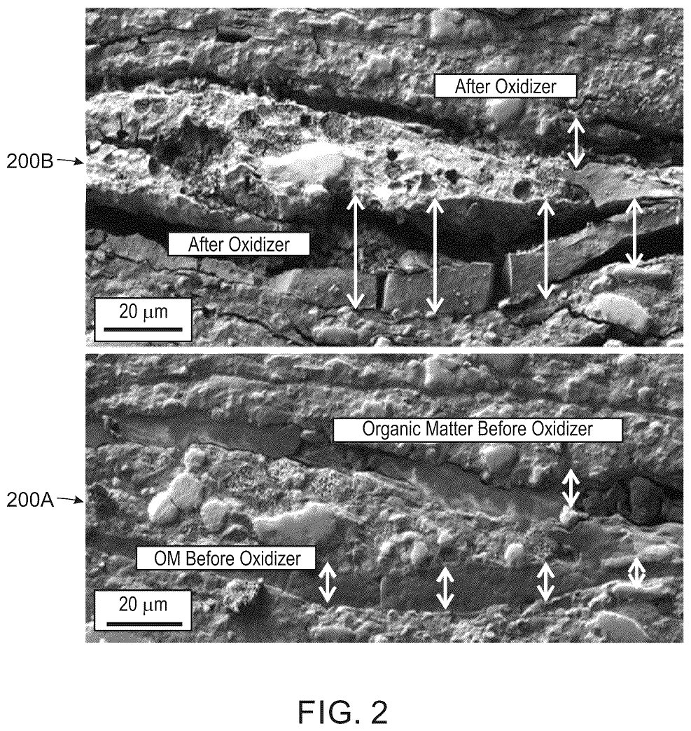

FIG. 2 shows increased porosity and permeability throughout the organic matter following an oxidative treatment of an organic-rich shale sample. In examples, FIG. 2 includes two scanning electron microscopy (SEM) images of a shale sample with two large organic veins running horizontally across each of the sample 200A and the sample 200B. The sample 200A shows a shale sample prior to treatment, and the sample 200B shows a shale sample in the same region as the sample 200A after the oxidative treatment. In embodiments, the oxidative treatment is a chemical treatment alters the rock/organic interfaces to increase the energy of CO₂ adsorption and storage gas volume. In the example of FIG. 2, treating with oxidative fluid results in significant cracking and permeability enhancement as shown in the sample 200B. In examples, mineralogical characterization of rock types leads to insights regarding the potential for carbon mineralization and storage potential shown by the samples 200A and 200B.

In examples, the identification of QPCUTS based on the predicted properties enables the slowing and mitigation of the effect of human-generated greenhouse gases on the atmosphere, and ultimately contributes to the reduction needed to avoid climate disasters. The present techniques identify space in deep underground geological reservoirs to sequester large volumes of CO₂. In examples, the present techniques identify and rank geological formations for CO₂ storage. Geological formations are porous, and can include permeable reservoir rock such as sandstone, limestone, dolomite, or mixtures of these rock types. The porous and permeable reservoir rock types are often overlain by an impermeable rock species such as shale. In embodiments, CO₂ sequestration and storage in this context is similar to CO₂ injection in depleted oil fields for enhanced oil recovery (EOR). Aside from oil producing reservoirs, geological formations with the desired rock characteristics are also distributed around the world with potentially large enough storage capacity that can significantly contribute to emission reduction and climate stabilization. The present techniques also enable the identification of aquifers for carbon mineralization. In carbon mineralization, captured CO₂ is stored permanently in the form of carbonate minerals, such as calcite or magnesite, mostly in brine or saline deep aquifers. In examples, carbon mineralization is done via ex-situ, in-situ and wastes/rock fragment based approaches, depending on the location where the reaction takes place. Specifically, for in situ carbon mineralization, CO₂ bearing fluids are circulated through suitable subsurface reactive rock formations. In examples, carbon mineralization takes place in any geological formation in which CO₂ is injected/stored. Brine/aquifers are more prone to mineralization due to the ready availability of free cations such as Ca2+ and Mg2+ but in principle even unconventional shale formations could undergo some mineralization processes. One of the challenges with mineralization is that precipitation of carbonate solids can block pores and reduce permeability, so mineralization may be preferred in formations with higher permeability and larger pore throats.

FIG. 3 shows a workflow 300 for training machine learning models to predict structural properties (porosity/permeability) and geological properties (facies and rock types) for flow and storage potential. The workflow 300 may be executed using the process 700 of FIG. 7, using the system 800 of FIG. 8. For ease of description, the target output variables 312 are TOC 302, grain density 304, porosity 306, permeability 308, and facies 310. However, the predicted properties are not limited to those described in FIG. 3.

The machine learning models 130 are trained to quantitatively predict and characterize formation and rock properties that impact flow, storage potential and treatability of a formation. The training input data sets 320 may be, for example, multimodal and multiscale data sets as described with respect to FIG. 1. The input data 320 are aggregated, cleaned, and preprocessed as described with respect to FIG. 1. When training the machine learning models, the input data sets 320 are training data that correspond to target output variables 312. Machine learning models 130 are trained to predict the target output variables based on input data from known geological formations.

The input data sets 320 used as training data are associated with the target output variables 312 according to their spatial as well as time information, as needed. In examples, when the spatial and time association are not included, the samples become an ensemble of independent sample points; otherwise the spatial and time association are incorporated using the spatial and/or time correlation or relations among the samples to improve the performance or enable doing tasks that are dependent on these spatial/time associations. For example, the input core image data (e.g., images 112 of FIG. 1) at particular well and depth locations correspond with the grain density, porosity and permeability at the same well and depth locations. In embodiments, for classification and prediction the associations are determined using supervised learning. Association refers to the mappings from the input data and the rock properties (geological as well as chemical) are being specific to certain spatial locations or certain type of locations. Each sample of the sample data set is a pair consisting of input data and the output properties. The resulting input-output data set forms a sample data set for the machine learning models 130. The sample data set is then partitioned into training, validation and testing data subsets, for example, in 75%, 15% and 10%, respectively. The percentages provided are for purposes of description. The percentages assigned to each subset can vary.

In examples, the machine learning models 130 of FIG. 3 include two different types of architectures, CNN/Unet for image or depth wise point input data and RNN network such as LSTM/GRU for sequence input data. The machine learning models 130 can include a machine learning model 132 and a machine learning model 134 as shown in FIG. 1. Referring to FIG. 1, the machine learning model 132 is a CNN/Unet for image or depth wise point input data. The machine learning model 134 is a LSTM/GRU for sequence input data. In some embodiments, a final layer for the machine learning model 132 and the machine learning model 134 is a regression layer that predicts formation or rock properties.

During training, the machine learning models 130 are first fitted over the training sample data where the misfit between the target output variables 312 and the predicted properties (e.g., predicted properties 152) are minimized over the machine learning model parameters, for instance the CNN/Unet weight coefficients, and validated over the validation set. The trained machine learning models 130 are applied to the testing samples where the associated target formation and rock properties are predicted and evaluated by comparing with the measured values to obtain the R-squared (R2) and mean squared error (MSE) performance measures. Once the models are trained, validated, and tested with satisfying performance, the trained machine learning models are applied to sample input data obtained from unknown formation sites to predict properties as described with respect to FIG. 1. In examples, a satisfying performance refers to obtaining high accuracy in training, validation and more importantly testing metrics, defined by R2, MSE, or other performance measures.

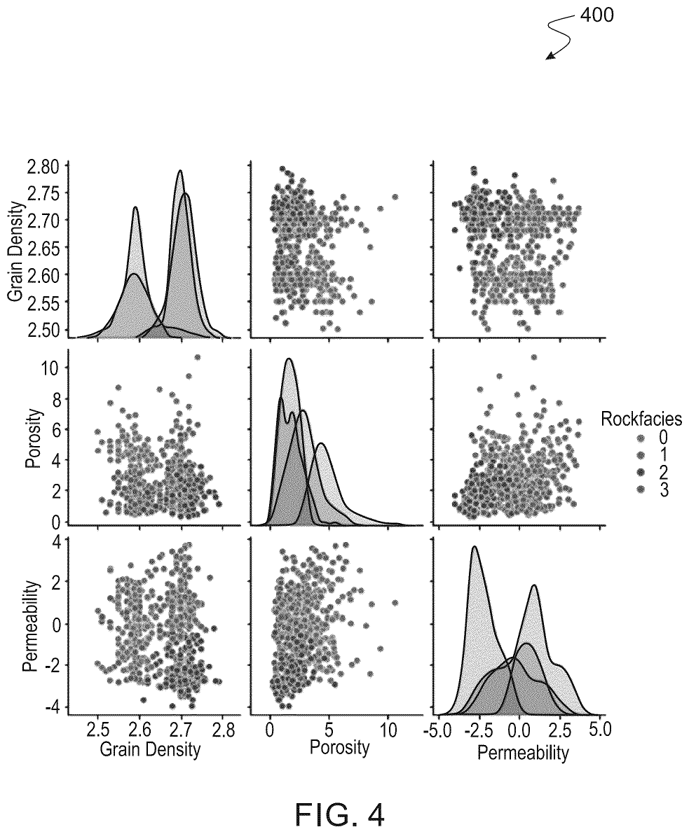

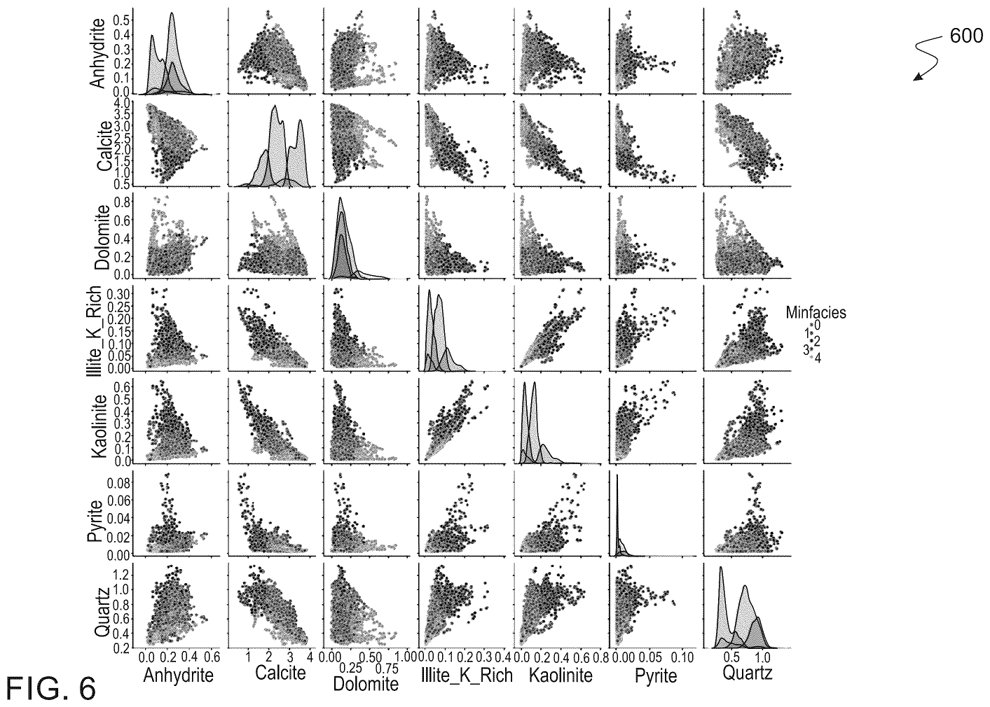

In examples, the machine learning models are facies specific, and trained using facies specific data. Facies specific data includes rock facies type as described with respect to FIG. 4, and chemical facies type as described with respect to FIG. 6. Pre-classification or clustering is applied to the training data samples. The training data samples are first grouped, either classified in a supervised manner via support vector machine (SVM) or deep learning classifiers if facies/rock type labels are available, or clustered in an unsupervised manner otherwise.

FIG. 4 shows rock facies type grouping based on structural properties (grain size, porosity and permeability) for flow and storage potential. The grouping shown in FIG. 4 can be applied to the workflow 100 of FIG. 1, the workflow 300 of FIG. 3, or any combinations thereof. In the example of FIG. 4, four classes of facies are shown, with the target output variables of grain density, porosity, and permeability shown for each facies group class or cluster. For each class or cluster, a machine learning prediction model is constructed, trained, validated and tested as described with respect to FIG. 3. In embodiments, input data to the trained machine learning models is preprocessed to be classified within a particular class/cluster before being provided as input to the corresponding machine learning model to predict properties.

FIG. 5 shows a workflow 500 for training machine learning models to predict chemical properties for flow and storage potential. The workflow 500 may be executed using the process 700 of FIG. 7, using the system 800 of FIG. 8. For ease of description, the target output variables 512 are TOC 502 and mineralogy 504 (e.g., mineralogical composition). However, the predicted properties are not limited to those described in FIG. 5. In examples, chemical properties include but are not limited to maturity, kerogen/bitumen ratio, and spatial distribution. In examples, the percentage of each chemical property present is predicted, such as the percent volume of TOC or other mineralogy, for fluid design of treatability. In examples, the predicted data 504 is output by machine learning models 130.

In the example of FIG. 5, the rock chemistry assists in fluid design to optimize the treatability of the rock. Similar to FIG. 3, the machine learning models 130 are trained to quantitatively predict and characterize chemical properties. The training input data sets 520 may be, for example, multimodal and multiscale data sets as described with respect to FIG. 1. The input data 520 are aggregated, cleaned, and preprocessed as described with respect to FIG. 1. When training the machine learning models, the input data sets 520 are training data that correspond to target output variables 512. Machine learning models 130 are trained to predict the target output variables based on input data from known geological formations. The input data sets 520 used as training data are associated with the target output variables 512 according to their spatial as well as time information, as needed. The resulting input-output data set forms a sample data set for the machine learning models 130, which can be partitioned into training, validation and testing data subsets as described with respect to FIG. 3.

FIG. 6 shows chemical facies type grouping based on chemical properties for fluid additives treatment potential. The grouping shown in FIG. 6 can be applied to the workflow 100 of FIG. 1, the workflow 300 of FIG. 3, the workflow 500 of FIG. 5, or any combinations thereof. In the example of FIG. 6, five classes of facies are shown, with the target output variables of anhydrite, calcite, dolomite, Illite (K rich), pyrite, and quartz is shown for each facies group class or cluster. For each class or cluster, a machine learning prediction model is constructed, trained, validated and tested as described with respect to FIG. 3. In embodiments, input data to the trained machine learning models is preprocessed to be classified within a particular class/cluster before being provided as input to the corresponding machine learning model to produce the target property prediction.

Prediction of geological structure properties can imply flow and storage potential; prediction of chemical properties provide information regarding treatability. In some embodiments, in the absence of direct measurements such as porosity or permeability, or in the presence of poor quality measurements of these properties, pressure/temperature, facies, and rock types and other input data is used to predict properties from places with similar pressure/temperature/facies/rock types. Using the predicted properties, carbon underground treatment and sequestration (QPCUTS) are identified for potential formations. Potential formations are identified by location, storage volume capacity and depth. The potential CO₂ storage capacity is quantified. The formations are sorted and ranked according to the storage and fluid treatment potential.

Using the workflow for data preprocessing (e.g., aggregation, cleaning, interpolation, extrapolation, concatenation, classification, or any combinations thereof) and the machine learning models for predicting the aforementioned formation and rock properties, a location of a formation is identified and quantified. For example, a location, depth and the associated storage volume capacity of formations of interest is determined. For a large number of formations where such sample data are available, the formations are quantified, sorted and ranked by storage and fluid treatment potential over the associated different location and depth. In examples, the QPCUTS are identified as shown with respect to FIG. 2.

In examples, the predicted properties are output as described above. For example, three types of formation and rock properties from various measurement data including well logs, core samples, geophysical survey data, etc. are predicted. The geological structural properties, the chemical properties including TOC and mineralogical properties, and the pressure, temperature, facies/rock types all contribute to the storage potential and treatability. Two sets of relationships are expressed in the following forms:

SVC(x,y,z)=f(SP,Tr;x,y,z) (1)

(SP,Tr)=g(ρ,ϕ,κ,toc,θ,rt) (2)

where SVC, SP, Tr denote the storage volume capacity, the storage potential, and the treatability, respectively. Equation (1) establishes SVC at the location (x, y, z) is a function of SP and Tr around (x, y, z). Equation (2) formulates the storage potential SP, the treatability Tr as functions of density ρ porosity ϕ, permeability κ, total organic content toc, mineralogical information θ, and facies/rock types rt, which have all been predicted from the available measurement data as described with respect to FIG. 1.

The calculated SVC(x, y, z) is a spatial distribution which can then be further processed and thresholded to identify the location, depth and the storage volume capacity.

Quantifying storage and fluid treatment potential is described using Equation (2). In Equation (2), given the predicted density ρ porosity ϕ, permeability κ, total organic content toc, mineralogical information θ, and facies/rock types rt, the storage and fluid treatment potential is computed using a connected volume calculation, with and without treatment. Sorting and ranking the storage and fluid treatment potential of the formations is done using the output of Equation (2).

FIG. 7 is a process flow diagram of a process 700 for quantitative prediction and sorting of carbon underground treatment and sequestration. The process 700 may include the workflow 100 of FIG. 1, workflow 300 of FIG. 3, or the workflow 500 of FIG. 5. In embodiments, the process 700 is implemented using the controller 800 of FIG. 8.

At block 702, multiple data sets are preprocessed. In embodiments, the multiple datasets include multi-modal and multiscale data sets. In embodiments, the preprocessing includes aggregating, cleaning, and integrating the data as described with respect to FIG. 1.

At block 704, the preprocessed data is input to trained machine learning models to predict organic content and rock matrix properties of a formation. Training the machine learning models is described with respect to FIGS. 3-6. In examples, the training data is data sets associated with one or more target output variables. Once the machine learning model is trained, validated, and tested, the target output variables are predicted properties output by the trained machine learning models in response to new input data. In examples, the new input data is preprocessed.

At block 706, the storage and treatment potential of the formation is ranked based on the predicted properties output by the trained machine learning models. In examples, the predicted properties include organic content and rock matrix properties. Once sample data and storage and fluid treatment potentials have been computed, they are sorted and ranked according to both the storage and fluid treatment potentials. In embodiments, formations are selected for storage and sequestration of CO₂ based on the sorted and ranked fluid treatment potentials.

The process flow diagram of FIG. 7 is not intended to indicate that the process 700 is to include all of the steps shown in FIG. 7. Rather, the process 700 can include fewer or additional elements not illustrated in FIG. 7 (for example, additional preprocessing, input data sets, target output variables, predicted variables). The process 700 of FIG. 7 may include any number of additional elements not shown, depending on the details of the specific implementation.

FIG. 8 is a schematic illustration of an example controller 800 (or control system) for quantitative prediction and sorting of carbon underground treatment and sequestration of potential formations to the present disclosure. For example, the controller 800 may be operable according to the workflow 100 of FIG. 1, workflow 300 of FIG. 3, the workflow 500 of FIG. 5, or the process 700 of FIG. 7. The controller 800 is intended to include various forms of digital computers, such as printed circuit boards (PCB), processors, digital circuitry, or otherwise parts of a system for automated decline curve analysis. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 800 includes a processor 810, a memory 820, a storage device 830, and an input/output interface 840 communicatively coupled with input/output devices 860 (for example, displays, keyboards, measurement devices, sensors, valves, pumps). Each of the components 810, 820, 830, and 840 are interconnected using a system bus 850. The processor 810 is capable of processing instructions for execution within the controller 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface via the input/output interface 840 at an input/output device 860.

The memory 820 stores information within the controller 800. In one implementation, the memory 820 is a computer-readable medium. In one implementation, the memory 820 is a volatile memory unit. In another implementation, the memory 820 is a nonvolatile memory unit.

The storage device 830 is capable of providing mass storage for the controller 800. In one implementation, the storage device 830 is a computer-readable medium. In various different implementations, the storage device 830 may be a floppy disk device, a hard disk device, an optical disk device, or a tape device.

The input/output interface 840 provides input/output operations for the controller 800. In one implementation, the input/output devices 860 includes a keyboard and/or pointing device. In another implementation, the input/output devices 860 includes a display unit for displaying graphical user interfaces. In embodiments, a user selects decline curve analysis using a fitted empirical model, trained artificial intelligence model, or any combinations thereof using a keyboard and/or pointing device, where the GUI is rendered via a display.

There can be any number of controllers 800 associated with, or external to, a computer system containing controller 800, with each controller 800 communicating over a network. Further, the terms “client,” “user,” and other appropriate terminology can be used interchangeably, as appropriate, without departing from the scope of the present disclosure. Moreover, the present disclosure contemplates that many users can use one controller 800 and one user can use multiple controllers 800.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method for quantitative prediction and sorting of carbon underground treatment and sequestration (QPCUTS) for potential formations, the method comprising:
preprocessing, with one or more hardware processors, multiple data sets, wherein the multiple datasets are multi-modal and multiscale data sets;
predicting, with the one or more hardware processors, geological structural properties, chemical properties, and geological properties by inputting the preprocessed multiple data sets into trained machine learning models; and
ranking, with the one or more hardware processors, the storage and treatment potential of a formation based on the predicted geological structural properties, chemical properties, and geological properties.

2. The computer implemented method of claim 1, wherein the trained machine learning models comprise a convolutional neural network that takes as input point data of the preprocessed multiple data sets.

3. The computer implemented method of claim 1, wherein the trained machine learning models comprise a recurrent neural network that takes as input sequence data of the preprocessed multiple data sets.

4. The computer implemented method of claim 1, wherein the final layer of the trained machine learning models is a regression layer that predicts at least one or the geological structural properties, the chemical properties, or the geological properties.

5. The computer implemented method of claim 1, wherein the trained machine learning models execute simultaneously to predict geological structural properties, chemical properties, and geological properties.

6. The computer implemented method of claim 1, wherein preprocessing the multiple datasets comprises applying interpolation to a first data set so that a dimension of the first data set is equal to a dimension of a second data set.

7. The computer implemented method of claim 1, wherein preprocessing the multiple datasets comprises partitioning the multiple datasets to match dimensions of inputs of the trained machine learning models.

8. An apparatus comprising a non-transitory, computer readable, storage medium that stores instructions that, when executed by at least one processor, cause the at least one processor to perform operations comprising:
preprocessing multiple data sets, wherein the multiple datasets are multi-modal and multiscale data sets;
predicting geological structural properties, chemical properties, and geological properties by inputting the preprocessed multiple data sets into trained machine learning models; and
ranking the storage and treatment potential of a formation based on the predicted geological structural properties, chemical properties, and geological properties.

9. The apparatus of claim 8, wherein the trained machine learning models comprise a convolutional neural network that takes as input point data of the preprocessed multiple data sets.

10. The apparatus of claim 8, wherein the trained machine learning models comprise a recurrent neural network that takes as input sequence data of the preprocessed multiple data sets.

11. The apparatus of claim 8, wherein the final layer of the trained machine learning models is a regression layer that predicts at least one or the geological structural properties, the chemical properties, or the geological properties.

12. The apparatus of claim 8, wherein the trained machine learning models execute simultaneously to predict geological structural properties, chemical properties, and geological properties.

13. The apparatus of claim 8, wherein preprocessing the multiple datasets comprises applying interpolation to a first data set so that a dimension of the first data set is equal to a dimension of a second data set.

14. The apparatus of claim 8, wherein preprocessing the multiple datasets comprises partitioning the multiple datasets to match dimensions of inputs of the trained machine learning models.

15. A system, comprising:
one or more memory modules;
one or more hardware processors communicably coupled to the one or more memory modules, the one or more hardware processors configured to execute instructions stored on the one or more memory models to perform operations comprising:
preprocessing multiple data sets, wherein the multiple datasets are multi-modal and multiscale data sets;
predicting geological structural properties, chemical properties, and geological properties by inputting the preprocessed multiple data sets into trained machine learning models; and
ranking the storage and treatment potential of a formation based on the predicted geological structural properties, chemical properties, and geological properties.

16. The system of claim 15, wherein the trained machine learning models comprise a convolutional neural network that takes as input point data of the preprocessed multiple data sets.

17. The system of claim 15, wherein the trained machine learning models comprise a recurrent neural network that takes as input sequence data of the preprocessed multiple data sets.

18. The system of claim 15, wherein the final layer of the trained machine learning models is a regression layer that predicts at least one or the geological structural properties, the chemical properties, or the geological properties.

19. The system of claim 15, wherein the trained machine learning models execute simultaneously to predict geological structural properties, chemical properties, and geological properties.

20. The system of claim 15, wherein preprocessing the multiple datasets comprises applying interpolation to a first data set so that a dimension of the first data set is equal to a dimension of a second data set.
